(19) United States
(12) Patent Application Publication
(10) Pub. No.: US 2006/0100361 A1
(43) Pub. Date: May 11, 2006

(54) Delayed crosslinking polycondensable composition, use thereof for producing coatings and resulting coatings

(75) Inventors: Jean-Marie Bernard, Saint-Laurent D'Agny (FR); Corinne Varron, Lyon (FR)

Correspondence Address: RHODIA INC., 259 PROSPECT PLAINS ROAD, CN 7500, CRANBURY, NJ, 08512, US

(73) Assignee: RHODIA CHIMIE

(21) Appl. No.: 10/539,998

(22) PCT Filed: Dec. 18, 2003
(86) PCT No.: PCT/FR03/03793

§ 371 Date: Jun. 17, 2005

(30) Foreign Application Priority Data
Dec. 24, 2002 (FR) 02/16633

(51) Int. Cl. C08G 18/08

(52) U.S. Cl. 524/589; 427/372.2

(57) ABSTRACT

The invention concerns a polycondensable composition capable of being used in coatings with delayed crosslinking, in particular at room temperature. The invention aims at providing a composition comprising: a) an additive composition between an aliphatic isocyanate and a nitrogenous five-membered heterocycle of aromatic type having a nitrogen-carbon-nitrogen sequence of the type —N(H)—C(—)═N—; b) at least one polyol, said heterocycle being substituted by at least one hydrocarbon chain having 1 to 10 carbon atoms. The invention is applicable to the coating industry.

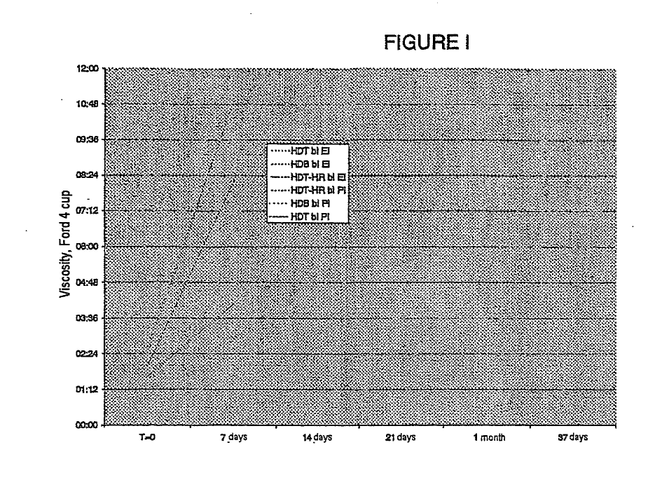

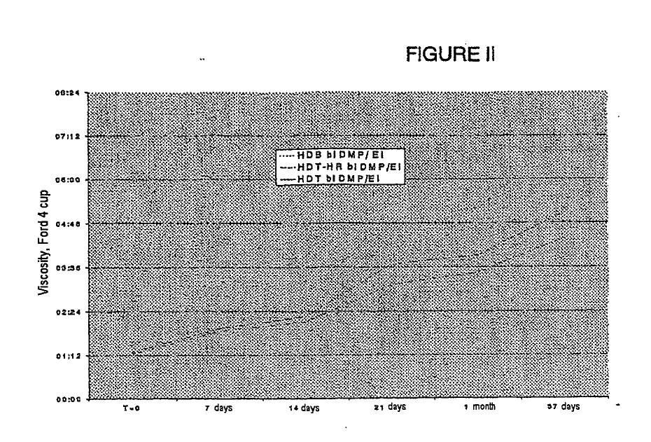

The present invention is targeted at a polycondensable composition which can be used for coatings and the crosslinking of which is delayed, in particular at ambient temperature.

A more particular subject matter of the invention is compositions having a lifetime after mixing which is increased. The present invention is also targeted at the use of the polycondensable compositions for producing coatings. Another subject matter of the invention is the coatings thus obtained.

The coatings industry, and in particular the paint and varnish industries, have available two types of compositions for producing high quality polyurethane paints or varnishes. According to one of the first types, use is made of true polyisocyanates, that is to say nonblocked polyisocyanates, and of polyols of a certain type. The coating thus obtained is of high quality.

However, the disadvantage of this technique is the speed with which polycondensation, resulting ipso facto in crosslinking, takes place. Usually, once the mixture has been prepared, the paint has to be applied very quickly, generally within a time of less than several hours. This technique results in relatively high wastage during untimely shutdowns of the paint line.

This type of paint and composition is denoted under the expression “2K” (abbreviation of the German expression meaning two components). Another type of composition has been developed; these are compositions denoted by “1K” which are composed of blocked isocyanates and which have a relatively high deblocking temperature, in the vicinity of 140° C. with catalyst. The polyols used for these compositions are different in nature.

This is why one of the aims of the present invention is to provide isocyanate-polyol compositions which give paints or varnishes of a quality at least equal to that of the “2K” mixtures.

Another aim of the present invention is to provide a composition of the preceding type which has a lifetime as a mixture at ambient temperature at least equal to 8 h, preferably of at least equal to one day. Another aim of the present invention is to provide compositions of the preceding type which require, to be crosslinked, only a temperature of at most 100° C. for a time of half an hour.

Thus, the invention is targeted at improving the productivity by sparing the user the trouble of preparing the coating composition all the time, as is required by the compositions formulated with polyisocyanates comprising free functional groups, which compositions are denoted under the expression “2K”. Furthermore, a loss of material during breakdowns on the line is avoided.

Finally, the invention makes it possible to prevent variability in the baths and more specifically in the preparations since, on the one hand, there will be fewer preparations for a given time period and, on the other hand, the variation according to the age of the preparation will be lower.

Thus, another aim of the present invention is to provide compositions for coatings on heat-sensitive materials, such as wood, plastic or paper, and on metal components which are not sensitive to heat but which are too big to pass into an oven heated at temperatures of between 150 and 200° C.

Another problem related to the long lifetime of the compositions is the fact that it is advisable to prevent this long lifetime from allowing the blocked isocyanates to crystallize, which blocked isocyanates frequently have a tendency to crystallize, which interferes with the subsequent crosslinking.

To sum up, it is a matter of finding a technique for blocking isocyanates such that the crosslinking occurs at a relatively low temperature, advantageously of between 50 and 100° C., in the possible presence of catalysts.

This blocking technique must make possible a high pot life and in particular a pot life at least equal to one day, preferably to two days.

The blocking technique must make possible physical stability during the storage of the coating formulation, that is to say that there must be neither phase separation nor crystallization.

Finally, the blocking technique must make it possible to confer, on the coating thus obtained, properties at least comparable with those obtained with nonblocked polyisocyanates.

These aims and others which will become apparent subsequently are achieved by a composition comprising:

a) an addition compound of an aliphatic isocyanate and of a five-membered nitrogenous heterocycle of aromatic nature exhibiting a nitrogen-carbon-nitrogen sequence of —N(H)—C(—)═N— type;

b) at least one polyol, said heterocycle being substituted by at least one hydrocarbon chain exhibiting from 1 to 10 carbon atoms.

The addition compound of an aliphatic isocyanate and of a five-membered aromatic nitrogenous heterocycle can be a compound completely blocked by said nitrogenous heterocycle. It can comprise up to 10% as equivalents of free isocyanate functional groups.

In addition, it can comprise other blocking agents than those corresponding to the definition of the nitrogenous heterocycle. In this case, it is preferable for, in equivalents, at least 50%, preferably at least ⅔, more preferably at least ¾, of the isocyanate functional groups to be blocked by the nitrogenous heterocycle as defined above.

The blocking agent corresponding to the definition of the nitrogenous heterocycle can be a mixture of compounds corresponding to the conditions defined above. In this case, it is preferable for at least 50%, preferably ⅔, of the isocyanate functional groups to be blocked by imidazole rings. This is because tetrazole rings, although able to be envisaged chemically, are difficult to employ and triazole rings are deblocked at a significantly higher temperature than that of imidazole.

It is preferable for the mean number of carbons of the blocking agents to be at most equal to 10 carbon atoms, with respect to a blocked isocyanate functional group, preferably at most equal to 6, more preferably at most equal to 5. It is preferable for this ratio to be at least equal to 4, preferably equal to 5, plus or minus 0.5.

Thus, during the research which has led to the present invention, it could be shown that, in the specific case of mixtures of protective groups, it was possible to use a certain amount of heterocyclic compounds not comprising pendent side chains in combination with protective groups possessing pendent chains. In order for the modified polyisocyanates not to crystallize in the final formulation, it is preferable for the (heterocyclic protective group without pendent chains/heterocyclic protective group comprising pendent chains) ratio to be generally less than 50%, preferably less than 40%.

It could also be shown that it was possible to introduce, into the mixture of protective groups, a certain amount of protective groups which only deblock at a higher temperature, in the vicinity of 130° C. or 140° C., in the presence of catalysts, such as pyrazoles, in particular dimethylpyrazole, this being the case up to levels at most equal to 50%, preferably to 40%, expressed as equivalents of blocked isocyanates. It is preferable to use polyisocyanates having an average molecular mass Mw of at least 1000.

When the five-membered heterocyclic derivative is monosubstituted, it is preferable for this substitution to take place on the carbon situated between the two nitrogens. The substituents of the five-membered heterocycle of aromatic nature, sometimes denoted under the expression of “pendent chains”, are advantageously linear or branched aliphatic or cycloaliphatic chains comprising at least 1 and at most 10 carbon atoms. They can optionally be interrupted by heteroatoms (for example, nitrogen, oxygen and sulfur). These substituents can also be perfluorinated chains. Generally, these substituents do not comprise flat structures, in particular aromatic structures, insofar as the latter are capable of resulting in crystallization of the modified polyisocyanates. It is also possible to provide other functional groups as substituents of the five-membered heterocyclic aromatic nucleus; in particular, ether or ester functional groups can connect the pendent chain to the heterocyclic nucleus.

Mention may be made, as examples of blocking agents which can be used in the present invention, of:

imidazole and its derivatives monosubstituted in the 2, 4 or 5 position, such as 2- or 4-methyl-, 2-ethyl-, 2-propyl-, 2-isopropyl-, or 2- or 4-phenylimidazole,

derivatives disubstituted in the 2,4, 2,5 or 4,5 positions, such as 2-ethyl-4-methylimidazole or 4-methyl-5-hydroxymethylimidazole or 4-methyl-2-phenylimidazole or ethyl 4-methyl-5-imidazole-carboxylate,

derivatives trisubstituted in the 2,4,5 positions, such as 2,4,5-triphenylimidazole.

The above compounds can be used with other blocking agents and in particular those mentioned below:

2-hydroxypyridine and its derivatives, such as 2-hydroxy-4-methylpyridine, 2-hydroxy-6-methyl-pyridine, 3-methoxy-2-pyridone, 2,6-dihydroxypyridine or 2-hydroxy-6-methylpyridinecarboxylic acid,

triazole derivatives.

As was mentioned above, in addition to the blocked or partially blocked isocyanate, the composition comprises a coreactant exhibiting at least two functional groups comprising a mobile hydrogen. These coreactants are advantageously polyols and, more particularly, the coreactant is advantageously a polyol having a hydroxyl content of between 1 and 5 g/100 g, advantageously between 3.5 and 4.5 g/100 g, expressed with respect to the material on a dry basis.

Use may be made, to this end, of polyacrylates comprising hydroxyl groups, polyesters or alkyds, or their mixtures. Preference is very particularly given to polyacrylates comprising hydroxyl groups, the molecular mass Mw of which ranges from 3000 to 50 000, advantageously from 5000. to 30 000. It is also preferable for the molecular mass Mn to range from 2000 to 20 000, preferably from 3000 to 10 000.

The molecular mass (Mw) is measured by gel permeation chromatography (GPC), taking polystyrene as reference. This method makes it possible to obtain at the same time Mw (average molecular mass) and Mn (number of molecules of average molecular mass). The elution solvent is THF.

These polyols are as described on pages 40 to 49 of “Waterborne & Sovent Based Surface Coating Resins and Their Applications”, vol. III, John Wiley & Sons, 1998.

The polyol polymer is generally in solution in an organic solvent. Mention may in particular be made, as solvent, of esters, aromatic hydrocarbons, ethers, ether esters or amides. Use may also be made of aqueous dispersions, emulsions or solutions of polyols or of aqueous/organic formulations.

According to an advantageous form of the present invention, the polyol can be a polyol with a high solids content (SC), the SC of which is between 60 and 100%.

Reference is now made to the isocyanates which act as precursors for the blocked isocyanates targeted by the present invention.

As was mentioned above, the isocyanates for which the invention is most advantageous are aliphatic isocyanates, that is to say those in which the nitrogen atom is bonded to a carbon of sp³ hybridization.

These aliphatic isocyanates, to be condensed with said five-membered nitrogenous heterocycle of aromatic nature exhibiting a nitrogen-carbon-nitrogen sequence of —N(H)—C(—)═N— type, are either isocyanate molecules, referred to as monomers, that is to say nonpoly-condensed, or heavier molecules resulting from one or more oligocondensation(s), or mixtures of the oligocondensates, optionally with monomer.

As will be clarified subsequently, the commonest oligocondensates are biuret, the dimer and the trimer (in the field under consideration, the term “trimer” is used to describe the mixtures resulting from the formation of isocyanuric rings from three isocyanate functional groups; in fact, there are, in addition to the true trimer, heavier products resulting from the trimerization).

Mention may in particular be made, as monomer, of polymethylene diisocyanates [for example, TMDI (TetraMethylene DiIsocyanate) and HDI (Hexamethylene DiIsocyanate=OCN—(CH₂)₆—NCO) and its isomers (methylpentamethylene diisocyanate)].

Mention may also be made of isophorone diisocyanate (IPDI), norbornane diisocyanate (NBDI), 1,3-bis(isocyanatomethyl)cyclohexane (BIC), H₁₂-MDI and cyclohexane-1,4-diisocyanate.

Mention may also be made of arylenedialkylene diisocyanates, such as OCN—CH₂-Ø-CH₂—NCO.

It is desirable, in the structure of the or of one of the isocyanate monomer(s), for the part of the backbone connecting two isocyanate functional groups to comprise at least one polymethylene sequence (CH₂)_{π}, where π represents an integer from 2 to 10, advantageously from 4 to 8. This preference affects the mechanical performances. When there are several sequences, the latter can be identical or different. In addition, it is desirable for at least one, preferably all, of these sequences to be free to rotate and therefore exocyclic.

In addition, it is preferable, for reasons of crystallinity, for, in the blocked polyisocyanate composition, at least 20% of the monomer units of the (poly)condensation product to exhibit a polymethylene sequence (CH₂)_{π} as specified above.

Thus, according to the present invention, the blocked polyisocyanate, pure or as a mixture, results from a polyisocyanate, that is to say possessing at least two isocyanate functional groups, advantageously more than two (possibilities of fractional values since it is generally a mixture of more or less condensed oligomers), which generally itself results from a precondensation or from a prepolymerization of a unit diisocyanate (sometimes described in the present description as “monomer”).

Generally, 90% of the molecules constituting the mixture of these prepolymers or of these precondensates before blocking have an average molecular mass at most equal to approximately 4000 (Mw), more commonly to approximately 2000 (Mw), the term “approximately” meaning that the positional zeros are not significant figures (in other words, just one figure is significant in this instance).

Thus, among the polyisocyanates used for the invention, mention may be made of those of the biuret type and those for which the di- or trimerization reaction has resulted in four-, five- or six-membered rings. Mention may be made, among the six-membered rings, of the isocyanuric rings resulting from a homo- or heterotrimerization of various diisocyanates alone, with other isocyanate(s) [mono-, di- or polyisocyanate(s)] or with carbon dioxide; in this case, a nitrogen of the isocyanuric ring is replaced by an oxygen. Oligomers comprising isocyanuric rings are preferred. Mention may also be made of the compounds resulting from the condensation with diols and triols (carbamates and allophanates) under substoichiometric conditions. Thus, in the isocyanate compositions, it is possible to find:

isocyanurate functional groups, which can be obtained by catalyzed cyclocondensation of isocyanate functional groups with themselves,

urea functional groups, which can be obtained by reaction of isocyanate functional groups with water or primary or secondary amines,

biuret functional groups, which can be obtained by condensation of isocyanate functional groups with themselves in the presence of water and of a catalyst or by reaction of isocyanate functional groups with primary or secondary amines,

urethane functional groups, which can be obtained by reaction of isocyanate functional groups with hydroxyl functional groups,

allophanate functional groups, which can be obtained by reaction of isocyanate functional groups with urethane functional groups,

uretidinedione functional groups, which can be obtained by cyclodimerization, optionally catalyzed, of isocyanate functional groups with themselves.

The preferred polyisocyanates are those which exhibit at least one aliphatic isocyanate functional group, advantageously all. In other words, at least one blocked isocyanate functional group according to the invention is connected to the backbone via a carbon of sp³ type advantageously carrying a hydrogen atom, preferably two hydrogen atoms. It is desirable for said carbon of sp³ type to be itself carried by a carbon of sp³ type advantageously provided with one, preferably with two, hydrogen atoms, this being the case in order to prevent the isocyanate functional group under consideration from being in the neopentyl position. In other words, it is advisable to choose, as monomers (which generally carry two isocyanate functional groups), at least one compound which carries at least one aliphatic functional group which is neither secondary nor tertiary nor neopentyl.

When the composition according to the invention comprises a mixture of isocyanates, it is generally preferable for said mixture to exhibit a mean functionality (number of blocked or nonblocked isocyanate functional groups per molecule comprising them) of greater than 2, advantageously at least equal to 2.1, and at most equal to approximately 15, advantageously to 7, preferably at least equal to 2.4 and at most equal to 4.

The present invention is advantageously implemented in solvents but it is also suitable for implementation in the form of a dispersion in an aqueous phase. Such a dispersion involves the use of surface-active agents and in particular of dispersants.

If an emulsion is involved, the latter can additionally comprise a water-immiscible solvent.

In the case of a dispersion, the continuous phase is an aqueous phase. The blocked isocyanates and the polyols can be in the same continuous phase or in two separate noncontinuous phases.

As has already been mentioned, solvents can be used in the context of the invention. These are solvents current in this field. Thus, the solvents are those which are well known to a person skilled in the art and are in particular aromatic solvents, such as benzene, ketones, such as cyclohexanone, methyl ethyl ketone and acetone, light alkyl esters, in particular butyl acetate and adipic esters; use may also be made of petroleum fractions of the type of those sold under the Solvesso trademark.

According to the present invention, it is also possible to carry out the blocking in situ, that is to say for the invention to target a composition which comprises, for successive or simultaneous addition:

a polyisocyanate to be blocked according to the invention;

a coreactant comprising a reactive hydrogen, in particular a polyol as described above;

a blocking agent which is a five-membered nitrogenous heterocycle of aromatic nature exhibiting a nitrogen-carbon-nitrogen sequence of —N(H)—C(—)═N— type in which said heterocycle is substituted by at least one hydrocarbon chain exhibiting from 1 to 10 carbon atoms, advantageously from 1 to 5.

It is obvious to a person skilled in the art that the hydrocarbon chain cannot be situated on the hydrogen-carrying nitrogen of the above sequence. This is because it is this hydrogen atom which will react with the isocyanate to form the blocked isocyanate with the creation of an —N(H)—CO—N(—)—C(—)═N— sequence. This sequence, and the other sequences.

As was mentioned above, it is more practical to use rings targeted by the present invention where the R substituent is on the carbon situated between the two nitrogens to give the —N(H)—C(R)═N— sequence.

According to the present invention, it is preferable for the five-membered heterocycle according to the present invention to be a heterocycle of imidazole nature as indicated below: 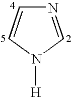
(imidazole backbone with the numbering of the positions which can be substituted)

As was specified in the first part of the description, it is preferable for the mean number of carbons of the blocking agents used in this implementation to be at least equal to 3.5.

It is also preferable for the molar proportion, or, if appropriate, in equivalents of cal molecule complex, such as imidazole, to be at least equal to 50%, preferably to ⅔, more preferably to ¾.

When the blocked compound is prepared in situ, it is preferable for the stoichiometric ratio of the blocking agents to the free isocyanate functional groups to be at most equal to 1.2, preferably to 1.1, more preferably to 1.

The relative amount of polyols and of isocyanate functional groups, blocked or to be blocked, varies between 0.1 and 10 times the stoichiometric amount, advantageously between ½ and 2 times the stoichiometric amount, and is more preferably equal to the stoichiometric amount plus or minus 30%.

The invention thus also relates to paint compositions comprising, for successive or simultaneous addition:

a blocked polyisocyanate according to the invention;

a coreactant comprising a reactive hydrogen as described above;

optional catalysts known per se (in particular those based on tin) which are optionally latent;

optionally at least one pigment;

optionally titanium dioxide;

optionally an aqueous phase;

optionally a surface-active agent for keeping the constituent components of the mixture emulsified or suspended;

optionally an organic solvent;

optionally a dehydrating agent.

The invention also relates to the paints and varnishes obtained by the use of these compositions, with the optional release according to the above process.

The present invention is also targeted at the use of the compositions of the present invention for producing coatings and in particular paints and varnishes. This use is implemented by a process for the application of a coat to the substrate to be coated, followed by heating at a temperature at most equal to 125° C., preferably at most equal to 110° C., for a period of time usually varying from half an hour to 2 h.

The thickness of the coat varies from 20 to 300 μm.

The following nonlimiting examples illustrate the invention.

### EXAMPLE 1

### Synthesis of a Formulation Formed of Tolonate HDT Blocked with 2-Ethylimidazole (CMI 1415)

1210 g of N-methylpyrrolidone (NMP) and 1202 g of Tolonate® HDT, Rhodia, with an NCO content of 0.52 mol per 100 g (i.e. 6 mol of NCO), are successively added to a 6 l jacketed three-necked reactor equipped with a stirrer and a reflux condenser. The reaction mixture is stirred and 619 g of 2-ethylimidazole with a purity of 98% (with a molecular weight of 96.13), i.e. 6.3 mol, are added over 5 min. The temperature of the reaction medium changes from 20° C. to 69.4° C. 5 min after the end of the addition of the blocking agent. The reaction medium is then heated at 80° C. approximately until the IR spectrum indicates that virtually all the isocyanate functional groups have reacted, i.e. 4 h after the end of the addition of the blocking agent.

After cooling to ambient temperature, the product is decanted into a receiving bottle.

The characteristics of the blocked product are as follows:

Theoretical NCO content: 0.206 mol per 100 g of solution, i.e. 8.66% by weight of NCO functional group per 100 g of formulation.

The solids content is 60.2%.

The viscosity is 760 mPa·s at 25° C.

For the other examples, the preparation is carried out as for example 1 using, as starting polyisocyanates, Tolonate® HDT, Rhodia, with an NCO content of 0.52 mol per 100 g, or commercial Tolonate® DB (Biuret) from Rhodia, with an NCO content of 22% by weight, or Tolonate HDT HR from Rhodia and, as blocking agents, 2-ethylimidazole or 2-propylimidazole or 50/50 mol % mixtures with 3,5-dimethylpyrazole.

The characteristics of the products obtained are presented in the table below.

Products Tested Under Application Conditions

A series of products blocked by various simple or mixed blocking agents was synthesized for the purpose of tests of reactivity and of stability on storage under application conditions. The characteristics of the products are shown in the following table:

| | | Solids | Viscosity |
|---|---|---|---|
| | Potential | content (%) | at 25° C. |
| Type | NCO % | (in NMP) | (cP) |
| HDB blocked with ethylimidazole | 9.35 | 65 | 4070 |
| HDB blocked with | 8.62 | 65 | 3286 |
| propylimidazole | | | |
| HDB blocked with ethylimidazole/ | 9.36 | 65 | 1970 |
| 3,5-DMP (50/50) | | | |
| HDT-HR blocked with | 9.34 | 65 | 2410 |
| ethylimidazole | | | |
| HDT-HR blocked with | 8.62 | 65 | 3108 |
| propylimidazole | | | |
| HDT-HR blocked with | 9.36 | 65 | 1390 |
| ethylimidazole/3,5-DMP (50/50) | | | |
| HDT blocked with ethylimidazole | 8.6 | 60 | — |
| HDT blocked with propylimidazole | 8.49 | 65 | 1200 |
| HDT blocked with ethylimidazole/ | 9.20 | 65 | 1193 |
| 3,5-DMP (50/50) | | | |

After storing in the laboratory for 10 months, the products do not show signs of gelling.

Principle of the Extended Pot Life

Two-component polyurethanes are so called as the polyol (hydroxylated resin) and the isocyanate are supplied in two separate containers; they are mixed during application and, consequently, an increase in the viscosity of application occurs due to the reaction between the polyol and the isocyanate in the pot. The pot life is the time during which the mixture can be employed and is measured as the time necessary for the doubling of the initial viscosity.

Two-component polyurethanes are multipurpose: they can be applied to all substrates: metal, wood, plastic. Drying is carried out in the ambient air or is alternatively accelerated by heating.

In the case of one-component polyurethanes, the blocked isocyanate does not react at ambient temperature with the polyol. The two components are therefore formulated and stored in the same pot. In this instance, the polyurethane does not have a pot life. The disadvantage of such a system is that the reaction between the isocyanate and the polyol can only take place after thermal deblocking, generally above 140° C., which means that the substrate cannot be heat sensitive, such as wood and plastic.

Blocked isocyanates which deblock at temperatures below 100° C. exhibit the advantage of being used on some plastics (polypropylene or polyamide, for example) while not having the constraint of the pot life.

The major advantage of such isocyanates is that of being used in a two-component system but not having the constraint of the pot life; in this instance, the pot life will be greater than one day, instead of a few hours. This type of product is particularly advantageous in the case of catalyzed two-component systems, the pot life of which is necessarily shorter (2 to 4 h).

The advantage of the isocyanate with an extended pot life lies in an extension of the operating life of the product on line: increase in the productivity, no problem of the product setting solid in static mixers and spray guns, no need to clean the application equipment during pauses, better efficiency with regard to the amount of paint employed, and the like.

Results of the Tests Under Application Conditions

The hardeners are employed in a varnish based on Joncryl SC 922X (an acrylic polyol from S.C. Johnson, with 4.4% of OH and a solids content of 80%) in the absence of catalyst.

The NCO/OH ratio=1.05

The solids content during application is 60%.

The varnishes are applied to a sheet of glass with an applicator at 100 μm wet. After 30 min of desolvation, stoving is carried out for each varnish at 80° C. or at 120° C. for 30 min.

When the films of varnish have returned to ambient temperature, that is to say one hour after stoving, the Persoz hardness is measured and the chemical resistance is confirmed by means of the “MEK (methyl ethyl ketone) double rub” test; the varnish has to have a satisfactory Persoz hardness and resistance to at least 200 double rubs.

Details of the results are given in the following table:

| | 30 min | | 30 min | |
|---|---|---|---|---|
| | 90° C. | | 120° C. | |
| | | MEK | | MEK |
| | Persoz | double | Persoz | double |
| | hardness | rub | hardness | rub |
| HDT blocked with | 170 | >200 | 305 | >200 |
| ethylimidazole | | | | |
| HDB blocked with | 172 | >200 | 305 | >200 |
| ethylimidazole | | | | |
| HDT-HR blocked with | 222 | >200 | 318 | >200 |
| ethylimidazole | | | | |
| HDB blocked with | 78 | 10 | 117 | >200B |
| 3,5-DMP/ethylimidazole | | | | |
| HDT-HR blocked with | 74 | 10 | 126 | <200B |
| 3,5-DMP/ethylimidiazole | | | | |
| HDT blocked with | 67 | 10 | 147 | >200B |
| 3,5-DMP/ethylimidazole | | | | |
| HDT-HR blocked with | 120 | >200 | 300 | >200 |
| propylimidazole | | | | |
| HDB blocked with | 121 | 150 | 311 | >200 |
| propylimidazole | | | | |
| HDT blocked with | 180 | >200 | 323 | >200 |
| propylimidazole | | | | |

The products blocked with ethylimidazole appear to offer the best compromise: they make possible deblocking from 90° C. Subsequent deblocking tests at 80° C. do not give conclusive results.

The stability of the varnishes is evaluated by leaving the 2K varnishes at 23° C.

The products based on propylimidazole appear to be slightly less reactive.

The HDT blocked with ethylimidazole gives the most advantageous results in terms of stability on storage. Stability on storage at 23° C. without catalyst, see FIGS. I and II.

1-9. (canceled)

10. A composition comprising, for successive or simultaneous addition:
a) an addition compound of an aliphatic isocyanate and of a five-membered nitrogenous heterocycle of aromatic nature exhibiting a nitrogen-carbon-nitrogen sequence of —N(H)—C(—)═N— type;
b) at least one polyol; and
c) said heterocycle being substituted by at least one hydrocarbon chain exhibiting, on average, from 1 to 10 carbon atoms per heterocycle.

11. The composition as claimed in claim 10, wherein said substituent is situated on a carbon surrounded by two nitrogens so that said sequence becomes —N(H)—C(R)═N—, wherein R is a hydrocarbon chain exhibiting from 1 to 10 carbon atoms.

12. The composition as claimed in claim 10, wherein said hydrocarbon chain, exhibits from 2 to 5 carbon atoms per five-membered nitrogenous heterocycle of aromatic nature.

13. The composition as claimed in claim 11, wherein R exhibits from 2 to 5 carbon atoms per five-membered nitrogenous heterocycle of aromatic nature.

14. The composition as claimed in claim 10, wherein said addition compound is an addition compound of an aliphatic isocyanate and of several blocking agents with a mean number of carbons of the blocking agents per blocked isocyanate functional group at least equal to 3.5.

15. The composition as claimed in claim 10, wherein the addition compound is prepared in situ.

16. The composition as claimed in claim 10, wherein the addition compound is a compound blocked by more than one blocking agent and in that, among the blocking agents, said five-membered nitrogenous heterocycles of aromatic nature represent at least 50% in equivalents.

17. A composition comprising, for successive or simultaneous addition:
a) an at least partially aliphatic isocyanate;
b) a five-membered nitrogenous heterocycle of aromatic nature exhibiting a nitrogen-carbon-nitrogen sequence of —N(H)—C(—)═N— type; and
c) at least one polyol,
wherein said heterocycle is substituted with at least one hydrocarbon chain exhibiting from 1 to 10 carbon atoms per heterocycle.

18. Coatings comprising a composition as defined in claim 10.

19. A process for coating a substrate, comprising the steps of:
a) spreading a coat of a composition as defined in claim 10 over said substrate, and
b) subjecting said composition to stoving at a temperature ranging from 50° C. to 120° C., for a period of time at least equal to ½ h.

20. A process according to claim 19, wherein the temperature ranges from 50° C. to 100° C., for a period of time at most equal to 2 h
